(19) United States
(12) Patent Application Publication
(10) Pub. No.: US 2026/0195833 A1
(43) Pub. Date: Jul. 9, 2026

(54) System and Method for Facilitating Legal Services Through an Online Marketplace Platform

(71) Applicant: Felix Martinez, Phoenix, AZ (US)

(72) Inventor: Felix Martinez, Phoenix, AZ (US)

(21) Appl. No.: 19/014,222

(22) Filed: Jan. 9, 2025

(51) Int. Cl. G06Q 50/18; G06Q 10/1093; G06Q 30/0601

(52) U.S. Cl. CPC G06Q 50/18; G06Q 10/1093; G06Q 30/0611

(57) ABSTRACT

The present invention relates to a system and method for facilitating legal services through an online marketplace platform. The system comprises one or more processors and a memory storing instructions to provide a user interface for clients to access a legal information library, select attorneys based on experience and budget, and submit offers for legal services. Natural language processing and machine learning algorithms analyze case information to determine a pool of relevant attorneys. The system generates a virtual contract between the client and selected attorney, schedules appointments, and utilizes encrypted databases and blockchain technology to ensure security, privacy, and integrity of transactions. The invention streamlines the client-attorney matching process, empowers informed decision-making, and ensures fair pricing for legal services.

### BACKGROUND

### Field of Invention

The present invention relates to the field of online legal services marketplaces that connect clients with attorneys based on their needs and budget.

### Description of Prior Art

Traditionally, clients seeking legal assistance for a particular issue must go through a time-consuming process of obtaining referrals, contacting individual lawyers, and conducting consultations to determine the best fit for their case and budget. Existing online legal services, such as LegalZoom, primarily focus on providing do-it-yourself legal forms with limited attorney assistance, while platforms like Avvo and FindLaw serve as directories for users to browse attorney profiles and contact them directly.

However, these conventional methods and existing platforms often leave clients with insufficient information to make informed decisions and do not offer a personalized attorney selection process based on client preferences and budget. The consultation process remains cumbersome and inefficient, leading to frustration and potential negative impacts on case outcomes.

Some attempts have been made to address these issues, such as the method and system for internet delivery of legal services described in WO2001009781A2. This prior art provides a website linked to legal specialists who receive and reply to client emails after the client pays a fee through the site, aiming to maintain solicitor/client privilege. However, it lacks the comprehensive legal information library and robust bidding system that are crucial for empowering clients to make informed decisions and efficiently connect with attorneys that align with their needs and budget.

Accordingly, there exists a need for an improved online legal services marketplace that provides clients with a comprehensive library of legal information, a transparent attorney selection process based on experience and budget, and an efficient bidding system to streamline the client-attorney matching process while ensuring fair pricing.

### SUMMARY

The present invention is directed to a system and method for facilitating legal services through an online marketplace platform. The system addresses the limitations of traditional methods and existing platforms by providing a comprehensive legal information library, a transparent attorney selection process based on experience and budget, and an efficient bidding system to streamline the client-attorney matching process.

The system comprises one or more processors and a memory coupled to the processors, storing instructions that, when executed, cause the system to perform various functions. The system provides a user interface that allows clients to access a comprehensive library of legal information covering various aspects of law, including procedures, charges, penalties, and court processes. This empowers clients to make informed decisions about their legal matters.

Through the user interface, clients can select a type of attorney based on experience level and bid range. The system receives an offer for legal services from the client, including case information and payment details. It then determines a pool of attorneys meeting the requirements for the legal services based on the offer and transmits the offer to this pool of attorneys.

Interested attorneys respond to the offer, and the system provides the client with a list of these attorneys as options. Upon the client's selection of an attorney, the system generates a virtual contract between the client and the selected attorney. It also schedules an appointment for them to establish a relationship.

The system leverages advanced technologies to enhance the legal services facilitation process. It utilizes natural language processing and machine learning algorithms to analyze case information, extract key details, and categorize legal matters. This enables the system to accurately determine the pool of attorneys with relevant expertise for each case.

To ensure security and privacy, the system stores client data, case information, and attorney-client communications in an encrypted database, with access provided only to authorized parties based on permission levels. It also facilitates secure communication channels between clients and attorneys, including video conferencing, instant messaging, and document sharing.

The system incorporates a rating and feedback mechanism, allowing clients to evaluate the legal services provided by attorneys. This information is used to update attorney profiles and rankings within the platform, promoting transparency and helping future clients make informed decisions.

In summary, the present invention provides an innovative system and method for facilitating legal services through an online marketplace platform. By offering a comprehensive legal information library, a transparent attorney selection process, and an efficient bidding system, the invention streamlines the client-attorney matching process, empowers clients to make informed decisions, and ensures fair pricing for legal services.

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a system architecture diagram illustrating an exemplary computing system environment for facilitating legal services according to one embodiment.

FIG. 2 illustrates an exemplary user interface for facilitating attorney selection, according to one embodiment.

FIG. 3 illustrates an offer matching and processing flow according to an embodiment of the present invention.

FIG. 4 is a flow diagram illustrating a method for generating a virtual contract between a client and a selected attorney and scheduling an appointment.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might”, or “may” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

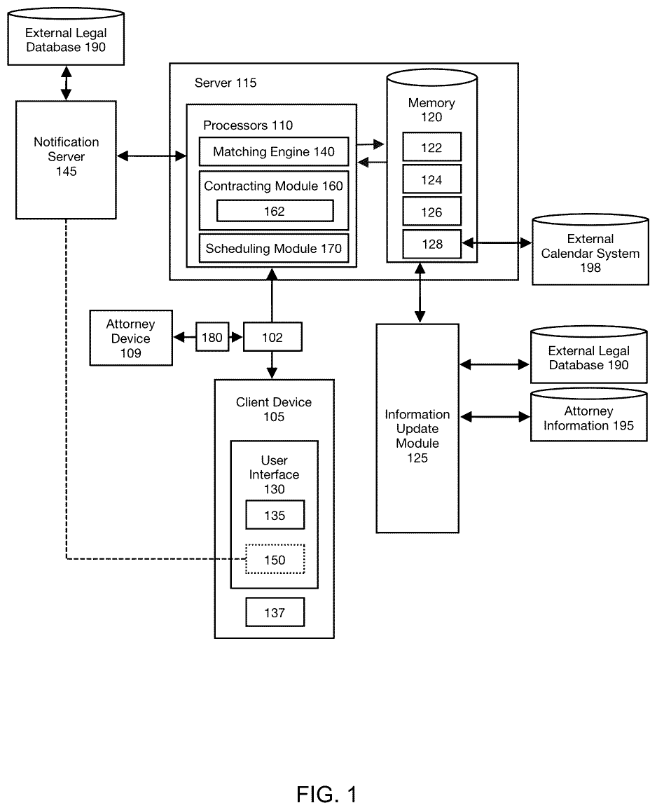

FIG. 1 is a system architecture diagram illustrating an exemplary computing system environment 100 for facilitating legal services according to one embodiment. The computing environment 100 includes one or more processors 110 communicatively coupled to a memory 120 via a high-speed system bus hosted on a server 115. The processors 110 may include single or multi-core CPUs, GPUs, DSPs, FPGAs, ASICs, or any other type of processing unit capable of executing programmatic instructions. The memory 120 stores a set of computer-readable instructions that, when executed by the processors 110, cause the computing environment 100 to provide the legal services facilitation functions described herein. The memory 120 may include volatile storage (e.g. RAM), non-volatile storage (e.g. ROM, flash, hard disk), or a combination thereof.

The memory 120 includes a comprehensive legal information library 122 covering various aspects of law, such as procedures, charges, penalties, court processes, legal templates, and statutory rules. In some embodiments, the legal information library 122 is implemented as a relational database management system (RDBMS) with data records organized into tables and indexed using a hierarchical taxonomy. The taxonomy may cover different legal practice areas, jurisdictions, and types of legal procedures. This allows the legal information to be efficiently searched and retrieved using structured query language (SQL) commands. The legal information library 122 is periodically updated with information received from external legal databases 190 via an information updating module 125.

A user interface component 130 is presented on a client device 105. The user interface 130 generates an interactive graphical display on the client device 105 that allows a client to specify criteria for selecting a type of attorney. For example, the interface may include controls, such as drop-down menus, slider bars, checkboxes, radio buttons, and text fields, for setting an experience level, bid range, location, and practice area for the attorney. In some embodiments, the user interface 130 provides a graphical query builder tool 135 that enables the client to visually construct a database query for searching attorney profile data. The query builder tool 135 may include condition blocks and connectors that the client can drag-and-drop to form a logical expression for the search criteria. The user interface client device 105 communicates with the server 115 via a network interface component 137 and network 102, which may comprise the Internet, a LAN, WAN, wireless network, or any suitable communications network.

The memory 120 also includes an attorney profile database 124 that stores profile data for a plurality of attorneys. The profile data for each attorney may indicate their name, contact information, experience level, practice areas, bar certifications, office location, hourly rate, languages spoken, and any other relevant attributes. The attorney profile database 124 is queried by a matching engine 140 executed by the processors 110 to determine a pool of attorneys meeting the requirements for legal services requested by a client. The attorney profile database 124 may be implemented using an RDBMS and periodically synchronized with external directories 195 storing attorney information via the information update module 125.

During operation, the user interface 130 receives an offer 150 for legal services from a client device 105. The offer 150 may include case information describing the facts and legal issues involved in the matter and payment details specifying a fee arrangement. The processors 110 execute the matching engine 140 to parse the case information into predefined data fields and formulate a database query based on the parsed case information and payment details. The database query is executed against the attorney profile database 124 using SQL commands to identify a pool of attorneys having attributes matching the criteria specified in the offer 150.

The matching engine 140 transmits the offer 150 to the pool of attorneys, for example, by generating an extensible markup language (XML) or JavaScript object notation (JSON) document with the case information and a hyperlink to a web-based interface for accepting the offer. The XML/JSON document is sent to a notification server 145, which transmits the offer to each attorney via an electronic messaging protocol, such as SMTP or SMS. The notification server 145 monitors the status of the offer 150 for each attorney by querying a response database 147 and updates the list of interested attorneys displayed to the client on the user interface 130 in real-time using asynchronous JavaScript and XML (AJAX) techniques.

When the client selects an attorney from the list, the processors 110 execute a contracting module 160 to generate a virtual contract between the parties. The contracting module 160 accesses a template repository 126 storing contract templates in a markup language format, such as XML or HTML. It selects an appropriate template based on the type of legal services, populates the template fields with the case and attorney information using a template engine 162, and transmits the contract to the client device 105 and an attorney device 109 for electronic signature. The contracting module 160 may use a cryptographic e-signature API 164 to validate the identities of the signatories and securely store the executed contract.

The processors 110 also execute a scheduling module 170 to book an appointment between the client and attorney. The scheduling module 170 accesses a calendar database 128 storing availability data and identifies a set of available time slots. It provides the time slots to the client via the user interface 130, receives a selected time slot, and creates a calendar event 175 in the calendar database 128. The scheduling module 170 may interface with external calendar systems 198 via an API to coordinate availability across multiple scheduling platforms.

Throughout the engagement, the computing environment 100 may monitor the progress of the legal services by transmitting periodic status update requests to the attorney device 109 via an attorney API 180. Upon conclusion, the client may submit a rating for the attorney via the user interface 130. The rating is used to update the attorney's profile score in the attorney profile database 124 and adjust their relative ranking. The rating may also be published to an external review platform via the API 180.

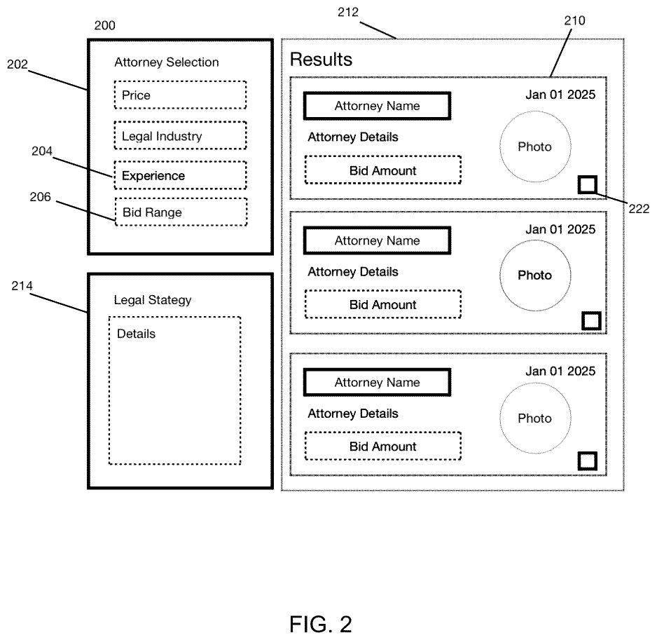

FIG. 2 illustrates an exemplary user interface 200 for facilitating attorney selection, according to one embodiment. The user interface 200 is configured to allow a client to select a type of attorney based on experience level and bid range.

The user interface 200 includes an attorney type selection module 202 that presents options for the client to specify desired attorney attributes. The attorney type selection module 202 may include input fields such as an experience level field 204 and a bid range field 206. The experience level field 204 allows the client to indicate a preferred level of experience for the attorney, such as a number of years practicing in a particular area of law. The bid range field 206 enables the client to specify a range of fees they are willing to pay for legal services.

In one embodiment, the attorney type selection module 202 is implemented as a graphical query builder tool (not shown) that enables the client to visually construct a database query specifying search criteria for selecting the type of attorney. The experience level field 204 and bid range field 206 may map to corresponding database fields storing attorney profile data in the attorney profile database 124.

The user interface 200 further includes an attorney list presentation module 208 that displays a list of attorneys 210 meeting the criteria specified by the client. The list of attorneys 210 represents a pool of attorneys determined to meet the requirements for the requested legal services based on the client's selections in the attorney type selection module 202. Each entry in the list of attorneys 210 may include attorney information such as name, photo, experience level, specialty, and bid range.

The user interface 200 also includes an attorney selection module 212 that allows the client to choose a specific attorney from the list of attorneys 210. The attorney selection module 212 may provide options such as checkboxes or radio buttons 222 next to each attorney entry, allowing the client to indicate their preferred attorney.

Additionally, the user interface 200 includes a legal strategy presentation module 214 that displays a customized legal strategy 216 generated for the client. The customized legal strategy 216 is based on a comprehensive library of legal information 122 covering various aspects of law and the specific case information provided by the client. The legal strategy presentation module 214 enables the client to review and understand the recommended legal approach for their case.

Furthermore, the user interface 200 may include a legal services recommendation module (not shown) that suggests additional legal services or resources to the client. The recommendations are based on the client's case information and their interactions with the platform. The legal services recommendation module aims to provide the client with relevant and helpful resources to support their legal needs.

In operation, the user interface 200 facilitates the attorney selection process by guiding the client through specifying their desired attorney attributes, presenting a list of qualified attorneys, and enabling the client to choose their preferred attorney. The user interface 200 also provides the client with a customized legal strategy and recommendations for additional legal services, enhancing their overall experience and support within the legal services platform.

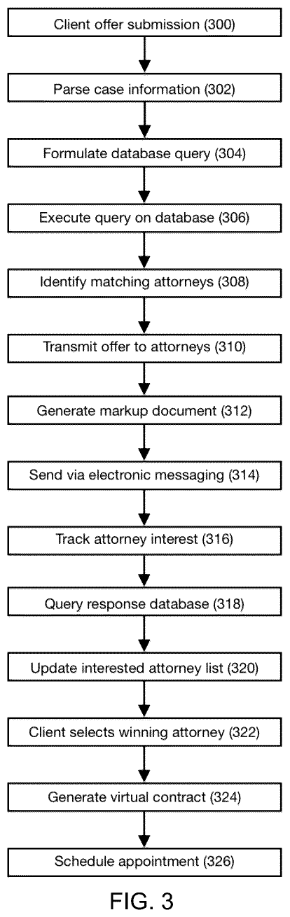

FIG. 3 illustrates an offer matching and processing flow according to an embodiment of the present invention. The process begins with a client offer submission 300, which includes case information and payment details. The system parses the case information from the offer submission into predefined data fields in step 302. Based on the parsed case information and payment details, the system formulates a database query in step 304 to match attorneys meeting the requirements for the legal services specified in the offer.

The database query is executed against a relational database 306 storing attorney profile data 124 to identify a pool of attorneys 308 having matching attributes. The system then transmits the offer 150 to the matched pool of attorneys in step 310. In one embodiment, transmitting the offer 150 involves generating a markup language document 312 that includes the case information and a hyperlink to a web-based interface for accepting the offer 150. The markup language document is sent to each attorney in the pool via an electronic messaging protocol 314.

As responses are received from attorneys, the system tracks attorney interest 316 by monitoring the status of the offer 150 for each attorney in the pool. This is accomplished by querying a relational database 318 that stores offer response data in the response database 147. The system updates the attorney list presented to the client in real-time based on the monitored status. This allows the client to view an up-to-date list 320 of interested attorneys.

Once the client selects a winning attorney 322 from the list of interested attorneys, the offer 150 is terminated for the remaining attorneys in the pool. The system then proceeds to generate a virtual contract 324 using the contracting module 160 between the client and the selected attorney and schedule an appointment 326 using the scheduling module 170 for them to establish their working relationship.

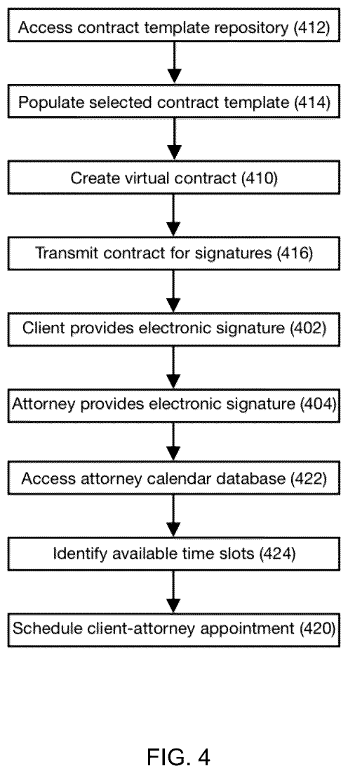

FIG. 4 is a flow diagram illustrating a method for generating a virtual contract 410 between a client 402 and a selected attorney 404 and scheduling an appointment 420. The method may be implemented by the legal services facilitation system 100 of FIG. 1.

The method begins by accessing a contract template repository 412 that stores contract templates in a markup language format. The contract template repository 412 may be part of the template repository 126 in the comprehensive library 122 of legal information. A suitable contract template is selected based on the type of legal services being provided. The selected contract template is then populated 414 by the template engine 162 with case information received from the client 402 in their offer for legal services 150, as well as information about the selected attorney 404. The case information may include details about the legal matter, while the attorney information may include the attorney's name, contact information, and payment details.

Once populated, the contract template becomes a virtual contract 410 between the client 402 and selected attorney 404. The virtual contract 410 is transmitted 416 to the client 402 and selected attorney 404 for them to provide electronic signatures using the cryptographic e-signature API 164 indicating their acceptance of the contract terms. To schedule an appointment 420 between the client 402 and selected attorney 404, the system accesses an attorney calendar database 422 that stores availability data for the selected attorney 404 in the calendar database 128. The availability data is used to identify a set of available time slots 424 for the attorney.

The following are process flows according to an embodiment of the present invention:
ATTORNEY ONBOARDING:
The attorney fills out a signup form.
The attorney receives a verification code via email.
The attorney verifies the account using the verification code.
After successful verification, the attorney signs in.
The attorney updates their profile and personal information and clicks “Update Profile”
The attorney then fills out a detailed application form, including fields such as areas of practice. The attorney completes, signs, and submits the form.
After submitting the application, the attorney is directed to the Agreement of Service with YourBestLawyer.com. The attorney must select their experienced law category, sign, and submit the agreement to proceed.
In this step, the attorney adds their credit card information to the system.
The attorney sets up their Stripe account by completing a multi-step Stripe-hosted wizard.
After completing the Stripe onboarding wizard, the attorney is redirected to the application preview page.
The attorney previews their application and can then submit it to the super admin for approval.
The super admin receives the application, assigns the correct law category and experience level to the attorney, and approves the application.
Once the application is approved, the attorney can log in to their dashboard and use the platform.
CUSTOMER ONBOARDING:
The customer fills out a signup form.
The customer receives a verification code via email.
The customer verifies the account using the verification code.
After successful verification, the customer signs in.
The customer updates their profile and personal information and clicks “Update Profile.”
The customer then lands on a detailed application form, where they select the law category, subcategory, and experience level of the attorney, and places a bid. The customer completes, signs, and submits the form.
At this step, the customer adds their credit card information to the system.
After adding the credit card, the customer creates a payment plan, choosing either full payment or instalment payments with date selection.
The customer previews the application after creating the payment plan and submits it.
The system displays the customer's application to relevant attorneys as a case lead.
Attorneys view the case details and place a bid.
The customer receives the attorneys'bids, signs the contract with the selected attorney, and submits it back.
The attorney receives the signed contract and can either sign or reject it.
After the contract is signed, the customer is charged the agreed fee according to the selected payment plan, and the attorney pays the platform fee.
Once the attorney signs the contract, the customer and attorney can schedule a meeting and chat with each other. The customer is now able to access their dashboard.
APPLICATION PROCESSING FLOW:
The customer initiates a new case application from their dashboard by filling out the application form, where they select the law category, subcategory, and the experience level of the attorney, and place a bid. The customer completes, signs, and submits the form.
The customer then creates a payment plan, choosing either full payment or instalment payments with selected dates.
After creating the payment plan, the customer previews the application and submits it.
The system displays the customer's application as a case lead to relevant attorneys.
Attorneys review the case details and place a bid.
The customer receives bids from the attorneys, signs a contract with the selected attorney, and submits it back.
The attorney receives the contract and can either sign or reject it.
After the contract is signed, the customer is charged the agreed fee according to the selected payment plan, and the attorney pays the platform fee.
Once the attorney signs the contract, the customer and attorney can schedule a meeting and chat with each other. The customer can now access their dashboard.
The attorney may complete the contract by clicking the “End Contract” button after receiving all payments from the customer.
Finally, the customer can rate the attorney.
The technology stack includes the following:
Web App Backend: Built with Laravel, providing a robust backend framework for application logic, user management, and data handling.
Web App Frontend: Developed using Laravel Blade templating engine and Bootstrap, offering a responsive and user-friendly interface.
Database: MySQL, used for reliable data storage, supporting relational data management and scalability.
Payment Gateway: Integrated with Stripe, enabling secure and seamless processing of transactions within the app.
Mobile App: Created with Flutter, ensuring cross-platform compatibility and a smooth user experience on both iOS and Android devices.
Mobile App Backend APIs: Powered by Laravel, providing the mobile app with reliable APIs for data exchange and backend interactions.

Another aspect of the invention is determining by an application-specific integrated circuit (ASIC) for an artificial neural network associated with the one or more processors a pool of attorneys meeting requirements for the legal services based on the offer, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits, wherein the array is configured to analyze a pool of attorneys meeting requirements for the legal services based on the offer on historical datasets associating attorneys with requirements for legal services, wherein the AI/ML categorization engine makes a prediction regarding a pool of attorneys meeting requirements for the legal services based on the offer.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A system for facilitating legal services, comprising:
one or more processors;
a memory coupled to the one or more processors, the memory storing instructions that, when executed by the one or more processors, cause the system to:
provide a comprehensive library of legal information covering various aspects of law, comprising procedures, charges, penalties, and court processes;
present a user interface allowing a client to select a type of attorney based on experience level and bid range;
receive, from the client, an offer for legal services including case information and payment details;
determine a pool of attorneys meeting requirements for the legal services based on the offer;
transmit the offer to the pool of attorneys;
receive interest in the offer from one or more attorneys in the pool of attorneys;
provide the client with a list of interested attorneys as options;
receive a selection of an attorney from the list of interested attorneys by the client;
generate a virtual contract between the client and the selected attorney; and
schedule an appointment between the client and the selected attorney to establish a relationship.

2. The system of claim 1, wherein the comprehensive library of legal information is stored in a relational database and indexed using a hierarchical taxonomy covering different legal practice areas, jurisdictions, and types of legal procedures.

3. The system of claim 1, wherein the user interface includes a graphical query builder tool that enables the client to visually construct a database query specifying search criteria for selecting the type of attorney, including experience level and bid range fields that map to corresponding database fields storing attorney profile data.

4. The system of claim 1, wherein determining the pool of attorneys meeting requirements for the legal services comprises:
parsing the case information from the offer into predefined data fields;
formulating a database query based on the parsed case information and payment details; and
executing the database query against a relational database storing attorney profile data to identify the pool of attorneys having matching attributes.

5. The system of claim 1, wherein transmitting the offer to the pool of attorneys comprises:
generating a markup language document including the case information and a hyperlink to a web-based interface for accepting the offer; and
sending the markup language document to each attorney in the pool of attorneys via an electronic messaging protocol.

6. The system of claim 1, wherein the memory stores additional instructions that, when executed by the one or more processors, cause the system to:
monitor a status of the offer for each attorney in the pool of attorneys by querying a relational database storing offer response data;
update the list of interested attorneys displayed to the client in real-time based on the monitored status; and
terminate the offer upon the client selecting an attorney from the list of interested attorneys.

7. The system of claim 1, wherein the memory stores additional instructions that, when executed by the one or more processors, cause the system to:
access a template repository storing contract templates in a markup language format;
select a contract template for the virtual contract based on the type of legal services;
populate fields of the selected contract template with the case information and attorney information; and
transmit the populated contract template to the client and the selected attorney for electronic signature.

8. The system of claim 1, wherein scheduling the appointment comprises:
accessing a calendar database storing availability data for the selected attorney;
identifying a set of available time slots for the selected attorney based on the availability data;
providing the set of available time slots to the client via the user interface;
receiving a selected time slot from the client; and
creating a calendar event for the appointment in the calendar database based on the selected time slot.

9. The system of claim 1, wherein the memory stores additional instructions that, when executed by the one or more processors, cause the system to:
receive a rating for the selected attorney from the client via the user interface after completion of the legal services;
update an attorney profile score for the selected attorney in a relational database based on the received rating; and
adjust a ranking of the selected attorney relative to other attorneys in the pool of attorneys based on the updated attorney profile score.

10. The system of claim 1, wherein the memory stores additional instructions that, when executed by the one or more processors, cause the system to:
monitor progress of the legal services by transmitting periodic status update requests to the selected attorney via an application programming interface (API);
receive status update responses from the selected attorney via the API, the status update responses including a description of legal activities performed and a percentage of the legal services completed; and
display the status update responses to the client via the user interface.

11. A method for facilitating legal services, comprising:
providing, by one or more processors, a comprehensive library of legal information covering various aspects of law, including procedures, charges, penalties, and court processes;
presenting, by the one or more processors, a user interface allowing a client to select a type of attorney based on experience level and bid range;
receiving, by the one or more processors, an offer for legal services from the client, the offer including case information and payment details;
determining by an application-specific integrated circuit (ASIC) for an artificial neural network associated with the one or more processors a pool of attorneys meeting requirements for the legal services based on the offer, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits, wherein the array is configured to analyze a pool of attorneys meeting requirements for the legal services based on the offer on historical datasets associating attorneys with requirements for legal services, wherein the AI/ML categorization engine makes a prediction regarding a pool of attorneys meeting requirements for the legal services based on the offer;
transmitting, by the one or more processors, the offer to the pool of attorneys;
receiving, by the one or more processors, interest in the offer from one or more attorneys in the pool of attorneys;
providing, by the one or more processors, the client with a list of interested attorneys as options;
receiving, by the one or more processors, a selection of an attorney from the list of interested attorneys by the client;
generating, by the one or more processors, a virtual contract between the client and the selected attorney; and
scheduling, by the one or more processors, an appointment between the client and the selected attorney to establish a relationship.

12. The method of claim 11, further comprising:
generating, by the one or more processors, a customized legal strategy for the client based on the comprehensive library of legal information and the case information provided by the client; and
presenting, by the one or more processors, the customized legal strategy to the client via the user interface.

13. The method of claim 11, further comprising:
analyzing, by the one or more processors, the case information using natural language processing and machine learning algorithms to extract key details and categorize the legal matter; and
utilizing, by the one or more processors, the extracted key details and categorization to determine the pool of attorneys with relevant expertise for the legal services.

14. The method of claim 11, wherein the comprehensive library of legal information is continuously updated, by the one or more processors, with changes to laws, regulations, and court precedents.

15. The method of claim 11, further comprising:
securely storing, by the one or more processors, client data, case information, and attorney-client communications in an encrypted database; and
providing, by the one or more processors, access to the encrypted database only to authorized parties based on permission levels.

16. The method of claim 11, further comprising:
monitoring, by the one or more processors, the progress of the legal services provided by the selected attorney; and
generating, by the one or more processors, periodic reports for the client detailing the status of the legal matter and any updates.

17. The method of claim 11, further comprising:
facilitating, by the one or more processors, secure communication channels between the client and the selected attorney, including video conferencing, instant messaging, and document sharing.

18. The method of claim 11, wherein the user interface allows the client to rate and provide feedback on the legal services provided by the selected attorney, and wherein the one or more processors use the ratings and feedback to update the attorney's profile and rankings within the platform.

19. The method of claim 11, further comprising:
recommending, by the one or more processors, additional legal services or resources to the client based on the case information and the client's interactions with the platform.

20. The method of claim 11, wherein the one or more processors use blockchain technology to securely record and verify transactions, including contract generation and payment processing, within the platform.
